(19) United States
(12) Patent Application Publication
(10) Pub. No.: US 2024/0017101 A1
(43) Pub. Date: Jan. 18, 2024

(54) FIRE SEALS FOR HIGH TEMPERATURE AND EXTREME ENVIRONMENTS

(71) Applicant: The Boeing Company, Chicago, IL (US)

(72) Inventor: Om Prakash, Bangalore (IN)

(73) Assignee: The Boeing Company, Chicago, IL (US)

(21) Appl. No.: 17/812,240

(22) Filed: Jul. 13, 2022

(51) Int. Cl. A62C 2/06

(52) U.S. Cl. CPC A62C 2/065; A62C 3/08

(57) ABSTRACT

A fire seal includes a bulk material and a phase-changing material supported by the bulk material. The bulk material of the fire seal is fire resistant.

### FIELD

This application relates to fire seals and, more particularly, to fire seals having ability to manage excessive temperatures and contain its damaging effect through incorporation of phase-change materials and other additives.

### BACKGROUND

Fire-seals and high temperature seals are subject to harsh operating conditions and thus require material properties relating to high temperature exposure, ignition, burn-through, hold-pressure, stability against variety of fluids, etc. With advancement in engines that operate at higher temperatures, greater functional performance is expected of sealing materials. Many current materials used for fire seals are expensive and are not capable of long-term exposure to harsh operating environments.

Accordingly, those skilled in the art continue with research and development efforts in the field of fire seals.

### SUMMARY

Disclosed are fire seals.

In one example, the disclosed fire seal includes a bulk material and a phase-changing material supported by the bulk material. The bulk material of the fire seal is fire resistant.

In another example, the disclosed fire seal includes a bulk material having a decomposition temperature. The bulk material is fire resistant. The fire seal further includes a phase-changing material supported by the bulk material, the phase-changing material having a phase transition temperature. The fire seal further includes a second phase-changing material supported by the bulk material, the second phase-changing material having a second phase transition temperature. A difference between the phase transition temperature and the second phase transition temperature is at least 50° C. A difference between the decomposition temperature and the phase transition temperature is at least 10° C. Further, a difference between the decomposition temperature and the second phase transition temperature is at least 10° C.

Also disclosed are multi-member assemblies.

In one example, the disclosed multi-member assembly includes a first structural member, a second structural member opposed from the first structural member, and a fire seal positioned between the first structural member and the second structural member, the fire seal includes a bulk material and a phase-changing material supported by the bulk material. The bulk material is fire resistant.

Also disclosed are fire-sealing methods.

In one example, the disclosed fire-sealing method includes positioning a fire seal between a first structural member and a second structural member. The fire seal includes a bulk material and a phase-changing material supported by the bulk material. The bulk material is fire resistant.

Other examples of the disclosed fire seals and associated multi-member assemblies and fire-sealing methods will become apparent from the following detailed description, the accompanying drawings, and the appended claims.

### BRIEF DESCRIPTION OF THE DRAWINGS

FIG. 1 is a cross-sectional schematic of a multi-member assembly;

FIG. 2 is a cross-sectional schematic of a fire seal of the multi-member assembly of FIG. 1;

FIG. 3 is a flow diagram of an aircraft manufacturing and service methodology; and

FIG. 4 is a schematic illustration of an aircraft.

### DETAILED DESCRIPTION

The following detailed description refers to the accompanying drawings, which illustrate specific examples described by the present disclosure. Other examples having different structures and operations do not depart from the scope of the present disclosure. Like reference numerals may refer to the same feature, element, or component in the different drawings.

Illustrative, non-exhaustive examples, which may be, but are not necessarily, claimed, of the subject matter according to the present disclosure are provided below. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

References throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

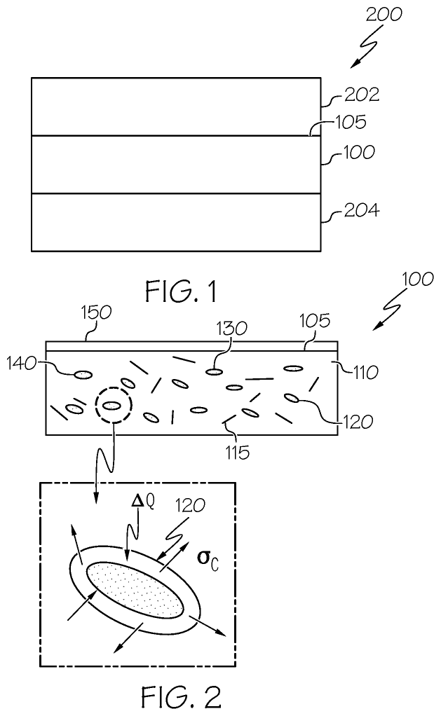

Referring to FIG. 1 and FIG. 2, disclosed is a fire seal 100. The fire seal 100 may be used in a vehicle, such as an aerospace component. The fire seal 100 assists in absorbing and dispersing heat within a multi-member assembly 200. The material properties of the fire seal 100 are selectively controlled by the chemistry of the fire seal 100. Factors include size, distribution, and fraction of inclusions and additives in the fire seal 100 as shown and described herein. The materials of the fire seal 100 are selected for high temperature and harsh environments, ignition, burn-through, hold-pressure, stability against variety of typical fluids, tolerance to thermal experience, and other requirements.

Referring to FIG. 2, the fire seal 100 includes a bulk material 110. The bulk material 110 is fire resistant. The bulk material 110 decomposes at a decomposition temperature T_{D}. In one example, the decomposition temperature T_{D} is at least 400° C. In another example, the decomposition temperature T_{D} is at least 500° C. In yet another example, the decomposition temperature T_{D} is at least 600° C.

The bulk material 110 may include any material having requisite material properties for the fire seal 100. The bulk material 110 may include a seal matrix-material. In one example, the bulk material 110 comprises a ceramic material. In another example, the bulk material 110 comprises a polymeric material. For example, the bulk material 110 may include aramid fibers, such as, for example, para-aramid material (e.g., KEVLAR brand fibers commercially available from DuPont) and/or a meta-aramid material (e.g., NOMEX brand fibers/sheets commercially available from DuPont). In another example, the bulk material 110 may include ceramic oxide fibers.

Further, the bulk material 110 may include one or more of an amorphous material, a fabric material, a foam material, and a felt material. Examples of a fabric material include Nextel™ (AF-10, AF-10-900) (trademarks of 3M™), Nomex® (HT-2002, HT001) (trademarks of Dupont™), Dacron™ (trademark of Dupont™), S2, and E-glass.

Referring to FIG. 2, the fire seal 100 further includes a phase-changing material 120 supported by the bulk material 110. The phase-changing material 120 includes particles having various sizes and distribution within the fire seal 100. In one example, the phase-changing material 120 includes particles having an average particle size of less than about 1 μm, such as particles having an average particle size within the range of about 0.01 μm to about 1 μm, or particles having an average particle size within the range of about 0.1 μm to about 1 μm, or particles having an average particle size within the range of about 0.5 μm to about 1 μm. In another example, the phase-changing material 120 includes an inorganic material (e.g., magnesium chloride hexahydrate (MgCl₂·6H₂O)). In yet another example, the phase-changing material 120 comprises a metallic material, such as a binary alloy (e.g., Al—Si, which phase changes at about 578° C., or Al—Sn, which phase changes at about 230° C.) or a ternary alloy (e.g., Cu—Al—Si, which phase changes at about 850° C.). Further, in one or more examples, the phase-changing material 120 may include a paraffin material.

The phase-changing material 120 absorbs heat within the fire seal 100 to reduce and slow material degradation when subjected to high temperatures for long periods of time and at high pressures. Referring to FIG. 2, heat input ΔQ into the phase-changing material 120 triggers latent-heat conversion, thus absorbing heat as it comes into contact with the fire seal 100. Further, expansion σ_{c} of the phase-changing material 120 due to phase change of the phase-changing material 120 triggers internal compression stress.

The phase-changing material 120 has a phase transition temperature T_{T}. In one example, the phase transition temperature T_{T} is between approximately 50° C. and approximately 1000° C. In another example, the phase transition temperature T_{T} is between approximately 100° C. and approximately 900° C. In yet another example, the phase transition temperature T_{T} is between approximately 250° C. and approximately 800° C.

In one or more examples, the phase-changing material 120 transitions from a solid to a liquid upon reaching the phase transition temperature T_{T}. In another example, the phase-changing material 120 transitions from a first solid to a second solid upon reaching the phase transition temperature T_{T}. In yet another example, the phase-changing material 120 transitions from a solid to a gas upon reaching the phase transition temperature T_{T}.

The phase transition temperature T_{T} and the decomposition temperature T_{D} of the bulk material 110 may be different. In one example, a difference between the phase transition temperature T_{T} and the decomposition temperature T_{D} is at least 10° C. In another example, a difference between the phase transition temperature T_{T} and the decomposition temperature T_{D} is at least 20° C. In yet another example, a difference between the phase transition temperature T_{T} and the decomposition temperature T_{D} is at least 30° C.

The fire seal 100 may further include a second phase-changing material 130 supported by the bulk material 110. In one example, the second phase-changing material 130 has a second phase transition temperature T_{T2}, and a difference between the second phase transition temperature T_{T2} and the decomposition temperature T_{D} is at least 10° C. Further, in one or more examples, a difference between a phase transition temperature T_{T} of the phase-changing material 120 the second phase transition temperature T_{T2} is at least 50° C. The second phase-changing material 130 may be compositionally different than the phase-changing material 120. For example, the phase-changing material 120 may be magnesium chloride hexahydrate (MgCl₂·6H₂O), which phase changes at about 117° C., and the second phase-changing material 130 may be tin (Sn), which phase changes at about 232° C.

Still referring to FIG. 2, in one or more examples, the fire seal 100 may further comprising a third phase-changing material 140 supported by the bulk material 110. The third phase-changing material 140 has a third phase transition temperature T_{T3}. In one example, a difference between the third phase transition temperature T_{T3} and the decomposition temperature T_{D} is at least 10° C. In another example, a difference between the third phase transition temperature T_{T3} and the decomposition temperature T_{D} is at least 20° C. For example, the phase-changing material 120 may be magnesium chloride hexahydrate (MgCl₂·6H₂O), which phase changes at about 117° C., the second phase-changing material 130 may be tin (Sn), which phase changes at about 232° C., and the third phase-changing material 140 may be Cu—Al—Si, which phase changes at about 850° C.

The fire seal 100 may further include a nano-clay material 115 supported by the bulk material 110. The nano-clay material 115 may be incorporated as a single layer or multiple layers to increase the diffusion barrier. For example, a high tortuosity diffusion path in the fire seal 100 material due to the addition of nano-clay material 115 may reduce the oxygen diffusion rate. A multi-layer assembly including nano-clay material 115 may help achieve ultra-low diffusion coefficients in the fire seal 100.

In addition to nano-clay material 115, in one or more examples, the fire seal 100 may include one or more additives to promote, among other things, CO₂ evolution beyond specific temperature thresholds. Specific examples of such additives include, but art not limited to, carbonates (e.g., calcium carbonate and sodium carbonate), bicarbonates (e.g., sodium bicarbonate), glucose, citrates, and the like, and mixtures thereof.

Examples of other additives include one or more of silica, alumina, zirconia, graphene, graphene oxide, and graphite oxide supported by the bulk material 110. Referring to FIG. 2, in one or more examples, the fire seal 100 may include an infrared-reflective coating 150 on an outside surface 105 of the fire seal 100. The infrared-reflective coating 150 may include inclusions that limit heat absorption in the material. The infrared-reflective coating 150 may include, for example, infrared-reflective pigments (e.g., leafing aluminum flakes) in a binder (e.g., thermoset resin).

In one non-limiting example, a fire seal 100 includes a bulk material 110 having a decomposition temperature T_{D}. The bulk material 110 is fire resistant. The fire seal 100 further includes a phase-changing material 120 supported by the bulk material 110. The phase-changing material 120 has a phase transition temperature T_{T}.

Referring to FIG. 2, the fire seal 100 further includes a second phase-changing material 130 supported by the bulk material 110, the second phase-changing material 130 having a second phase transition temperature T_{T2}. In one or more examples, a difference between the phase transition temperature T_{T} and the second phase transition temperature T_{T2} is at least 50° C. In another example, a difference between the decomposition temperature T_{D} and the phase transition temperature T_{T} is at least 10° C. and a difference between the decomposition temperature T_{D} and the second phase transition temperature T_{T2} is at least 10° C.

In one or more examples, see FIG. 2, the fire seal 100 includes a third phase-changing material 140 supported by the bulk material 110. The third phase-changing material 140 has a third phase transition temperature T_{T3}. In one example, a difference between the third phase transition temperature T_{T3} and the phase transition temperature T_{T} is at least 50° C. and a difference between the third phase transition temperature T_{T3} and the second phase transition temperature T_{T2} is at least 50° C.

Referring to FIG. 1, disclosed is a multi-member assembly 200. The multi-member assembly 200 includes a first structural member 202 and a second structural member 204 opposed from the first structural member 202. The multi-member assembly 200 further includes a fire seal 100 positioned between the first structural member 202 and the second structural member 204.

The fire seal 100 of the multi-member assembly 200 includes a bulk material 110. The bulk material 110 is fire resistant. The fire seal 100 of the multi-member assembly 200 further includes a phase-changing material 120 supported by the bulk material 110. In one example, the first structural member 202 of the multi-member assembly 200 is an engine and the second structural member 204 of the multi-member assembly 200 is a pylon.

Also disclosed is a fire-sealing method. The fire-sealing method includes the step of positioning a fire seal 100 between a first structural member 202 and a second structural member 204. The fire seal 100 of the fire-sealing method includes a bulk material 110 and a phase-changing material 120 supported by the bulk material 110. The bulk material 110 is fire resistant. In one example, the first structural member 202 is an engine and wherein the second structural member 204 is a pylon.

The phase-changing material 120 reversibly triggers latent heat conversion when subjected to specific temperature levels, thereby preventing further increase in temperature. Two or more families of phase-changing material 120, 130, 140, may be incorporated so that successive latent-heat conversion events get triggered at multiple increasingly higher temperature levels. This provides for multiple levels of safety and overall graceful response of seal material in the event of excessive temperature conditions. The fire seal 100 bulk material 110 incorporates nano-clay material 115 inclusions to provide a barrier to oxygen diffusion through the material, thereby restricting self-ignition and burn-through. The fire seal 100 and constituent inclusions are coated with IR reflective material, coating 150, to limit the incident temperature rise to an extent, thereby expanding the operation envelope of the current materials. The phase-change of the phase-changing material 120 inclusions is accompanied with an associated volume change, creating internal compression stress. This helps in maintaining pressure tightness even when the harsh surrounding conditions tend to create leakage paths. The fire seal 100 material may include inclusions that generate Co2 at the highest/extreme expected temperatures so as to extinguish any possible flame propagation through the joint.

The phase-changing material 120 and other functional additives supported by the bulk material 110 as shown and described herein are selected to enhance performance of seals, such as a fire seal 100. Specifically, phase-changing material 120 inclusions in seal matrix-material, or bulk material 110, reversibly absorb incident heat and limit temperature rise due to a latent-heat conversion process. The compressive stress induced due to associated volume change of the phase-changing material 120 provides extra benefit by ensuring tight sealing action even when rising temperature externally may lead to leakage through the fire seal 100 joint. The phase-changing material 120 may be based on solid-liquid or solid-solid phase transitions and is incorporated in sub-micron or plus-micron size along with other functional additives such as nano-clay material 115 to address the various functional requirements listed above. The composition and morphology of the phase-changing material 120 and bulk material 110 may be tailored to achieve desired performance relative to specific applications.

For example, the fire seal 100 materials may be selected such that the fire seal 100 is fireproof, does not have burn through, does not have backside ignition, is abrasion resistant, promotes self-extinguishing flames, holds pressure up to 30 psi, includes no hazardous quantity of fluid, vapor or flame can pass from one compartment to another doesn't absorb hazardous quantity of fluids survives in a nacelle/engine environment, is not susceptible to typical fluids (fuels, oils, hydraulic fluid, salt fog, deicing fluid, etc.), can withstand high (+500 F) and low (−65 F) temperatures, is fungus resistant, is sand and dust resistant, can withstand cyclic compression/pressure, is ozone resistant, is tolerant to build tolerances, thermal expansion and contraction, and maneuver deflections, and requires low closing force: ˜3-10 lb/linear inch.

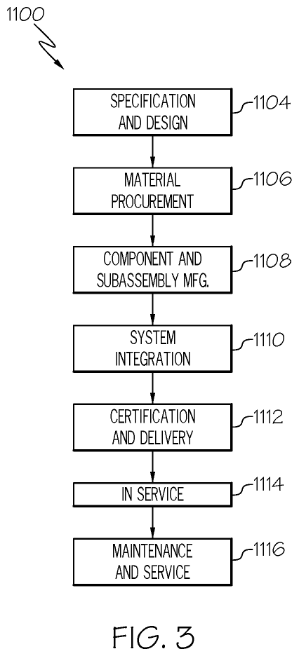

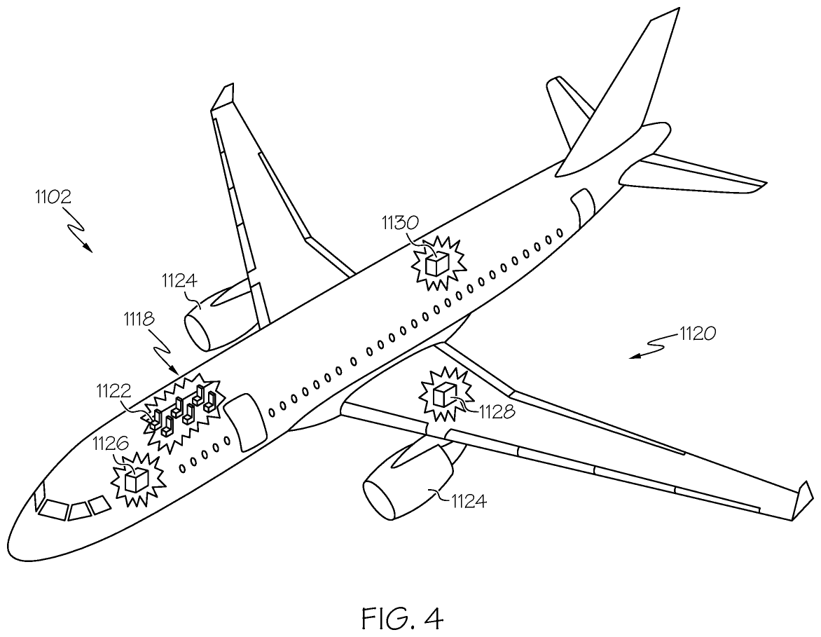

Specific polymeric systems that allow repair of damaged bonds through relatively straightforward post-treatment may also be included in the fire seal 100. Examples of the subject matter disclosed herein may be described in the context of aircraft manufacturing and service method 1100 as shown in FIG. 3 and aircraft 1102 as shown in FIG. 4. During pre-production, service method 1100 may include specification and design (block 1104) of aircraft 1102 and material procurement (block 1106). During production, component and subassembly manufacturing (block 1108) and system integration (block 1110) of aircraft 1102 may take place. Thereafter, aircraft 1102 may go through certification and delivery (block 1112) to be placed in service (block 1114). While in service, aircraft 1102 may be scheduled for routine maintenance and service (block 1116). Routine maintenance and service may include modification, reconfiguration, refurbishment, etc. of one or more systems of aircraft 1102.

Each of the processes of service method 1100 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 4, aircraft 1102 produced by service method 1100 may include airframe 1118 with a plurality of high-level systems 1120 and interior 1122. Examples of high-level systems 1120 include one or more of propulsion system 1124, electrical system 1126, hydraulic system 1128, and environmental system 1130. Any number of other systems may be included. Although an aerospace example is shown, the principles disclosed herein may be applied to other industries, such as the automotive industry. Accordingly, in addition to aircraft 1102, the principles disclosed herein may apply to other vehicles, e.g., land vehicles, marine vehicles, space vehicles, etc.

The disclosed fire seals and fire-sealing methods shown or described herein may be employed during any one or more of the stages of the manufacturing and service method 1100. For example, components or subassemblies corresponding to component and subassembly manufacturing (block 1108) may be fabricated or manufactured in a manner similar to components or subassemblies produced while aircraft 1102 is in service (block 1114). Also, one or more examples of the systems, methods, or combination thereof may be utilized during production stages component and subassembly manufacturing (block 1108) and system integration (block 1110), for example, by substantially expediting assembly of or reducing the cost of aircraft 1102. Similarly, one or more examples of the systems or method realizations, or a combination thereof, may be utilized, for example and without limitation, while aircraft 1102 is in service (block 1114) and/or during maintenance and service (block 1116).

The fire seals and fire-sealing methods are described in the context of an aircraft. However, one of ordinary skill in the art will readily recognize that the disclosed fire seals and fire-sealing methods may be utilized for a variety of applications. For example, the disclosed fire seals and fire-sealing methods may be implemented in various types of vehicles including, e.g., helicopters, watercraft, passenger ships, automobiles, various material processing equipment, and the like.

Further, the disclosure comprise examples according to the following clauses:

Clause 1. A fire seal (100) comprising: a bulk material (110); and a phase-changing material (120) supported by the bulk material (110), wherein the bulk material (110) is fire resistant.

Clause 2. The fire seal (100) of Clause 1, wherein the bulk material (110) decomposes at a decomposition temperature (T_{D}), and wherein the decomposition temperature (T_{D}) is at least 400° C.

Clause 3. The fire seal (100) of Clause 1, wherein the bulk material (110) decomposes at a decomposition temperature (T_{D}), and wherein the decomposition temperature (T_{D}) is at least 500° C.

Clause 4. The fire seal (100) of Clause 1, wherein the bulk material (110) decomposes at a decomposition temperature (T_{D}), and wherein the decomposition temperature (T_{D}) is at least 600° C.

Clause 5. The fire seal (100) of any preceding clause, wherein the bulk material (110) comprises a ceramic material.

Clause 6. The fire seal (100) of any preceding clause, wherein the bulk material (110) comprises a polymeric material.

Clause 7. The fire seal (100) of any preceding clause, wherein the bulk material (110) comprises an aramid polymer.

Clause 8. The fire seal (100) of any preceding clause, wherein the aramid polymer comprises a meta-aramid polymer.

Clause 9. The fire seal (100) of any preceding clause, wherein the bulk material (110) comprises ceramic oxide fibers.

Clause 10. The fire seal (100) of any preceding clause, wherein the bulk material (110) comprises an amorphous material.

Clause 11. The fire seal (100) of any preceding clause, wherein the bulk material (110) comprises a fabric material.

Clause 12. The fire seal (100) of any preceding clause, wherein the bulk material (110) comprises a foam material.

Clause 13. The fire seal (100) of any preceding clause, wherein the bulk material (110) comprises a felt material.

Clause 14. The fire seal (100) of any preceding clause, wherein the phase-changing material (120) has a phase transition temperature (T_{T}), and wherein the phase transition temperature (T_{T}) is between approximately 50° C. and approximately 1000° C.

Clause 15. The fire seal (100) of any preceding clause, wherein the phase-changing material (120) has a phase transition temperature (T_{T}), and wherein the phase transition temperature (T_{T}) is between approximately 100° C. and approximately 900° C.

Clause 16. The fire seal (100) of any preceding clause, wherein the phase-changing material (120) has a phase transition temperature (T_{T}), and wherein the phase transition temperature (T_{T}) is between approximately 250° C. and approximately 800° C.

Clause 17. The fire seal (100) of any preceding clause, wherein the phase-changing material (120) has a phase transition temperature (T_{T}) and the bulk material (110) has a decomposition temperature (T_{D}), and wherein a difference between the phase transition temperature (T_{T}) and the decomposition temperature (T_{D}) is at least 10° C.

Clause 18. The fire seal (100) of Clause 17, wherein a difference between the phase transition temperature (T_{T}) and the decomposition temperature (T_{D}) is at least 20° C.

Clause 19. The fire seal (100) of Clause 17, wherein a difference between the phase transition temperature (T_{T}) and the decomposition temperature (T_{D}) is at least 30° C.

Clause 20. The fire seal (100) of any preceding clause, wherein the phase-changing material (120) has a phase transition temperature (T_{T}), and wherein the phase-changing material (120) transitions from a solid to a liquid upon reaching the phase transition temperature (T_{T}).

Clause 21. The fire seal (100) of any preceding clause, wherein the phase-changing material (120) has a phase transition temperature (T_{T}), and wherein the phase-changing material (120) transitions from a first solid to a second solid upon reaching the phase transition temperature (T_{T}).

Clause 22. The fire seal (100) of any preceding clause, wherein the phase-changing material (120) has a phase transition temperature (T_{T}), and wherein the phase-changing material (120) transitions from a solid to a gas upon reaching the phase transition temperature (T_{T}).

Clause 23. The fire seal (100) of any preceding clause, wherein the phase-changing material (120) comprises particles having an average particle size of less than 1 μm.

Clause 24. The fire seal (100) of any preceding clause, wherein the phase-changing material (120) comprises an inorganic material.

Clause 25. The fire seal (100) of any preceding clause, wherein the phase-changing material (120) comprises a metallic material.

Clause 26. The fire seal (100) of any preceding clause, wherein the phase-changing material (120) comprises a paraffin material.

Clause 27. The fire seal (100) of any preceding clause, further comprising a second phase-changing material (130) supported by the bulk material (110).

Clause 28. The fire seal (100) of Clause 27, wherein: the second phase-changing material (130) has a second phase transition temperature (T_{T2}), the bulk material (110) has a decomposition temperature (T_{D}), and a difference between the second phase transition temperature (T_{T2}) and the decomposition temperature (T_{D}) is at least 10° C.

Clause 29. The fire seal (100) of Clause 27, wherein the second phase-changing material (130) has a second phase transition temperature (T_{T2}) and wherein a difference between a phase transition temperature (T_{T}) of the phase-changing material (120) the second phase transition temperature (T_{T2}) is at least 50° C.

Clause 30. The fire seal (100) of Clause 27, wherein the second phase-changing material (130) is compositionally different than the phase-changing material (120).

Clause 31. The fire seal (100) of Clause 27, further comprising a third phase-changing material (140) supported by the bulk material (110).

Clause 32. The fire seal (100) of Clause 31, wherein: the third phase-changing material (140) has a third phase transition temperature (T_{T3}), the bulk material (110) has a decomposition temperature (T_{D}), and wherein a difference between the third phase transition temperature (T_{T3}) and the decomposition temperature (T_{D}) is at least 10° C.

Clause 33. The fire seal (100) of any preceding clause, further comprising a nano-clay material (115) supported by the bulk material (110).

Clause 34. The fire seal (100) of any preceding clause, further comprising one or more of silica, alumina, zirconia, graphene, graphene oxide, and graphite oxide supported by the bulk material (110).

Clause 35. The fire seal (100) of any preceding clause, further comprising an infrared-reflective coating (150) on an outside surface (105) of the fire seal (100).

Clause 36. A fire seal (100) comprising: a bulk material (110) having a decomposition temperature (T_{D}), wherein the bulk material (110) is fire resistant; a phase-changing material (120) supported by the bulk material (110), the phase-changing material (120) having a phase transition temperature (T_{T}); and a second phase-changing material (130) supported by the bulk material (110), the second phase-changing material (130) having a second phase transition temperature (T_{T2}), wherein a difference between the phase transition temperature (T_{T}) and the second phase transition temperature (T_{T2}) is at least 50° C., wherein a difference between the decomposition temperature (T_{D}) and the phase transition temperature (T_{T}) is at least 10° C., and wherein a difference between the decomposition temperature (T_{D}) and the second phase transition temperature (T_{T2}) is at least 10° C.

Clause 37. The fire seal (100) of Clause 36, further comprising a third phase-changing material (140) supported by the bulk material (110), the third phase-changing material (140) having a third phase transition temperature (T_{T3}), wherein a difference between the third phase transition temperature (T_{T3}) and the phase transition temperature (T_{T}) is at least 50° C., and wherein a difference between the third phase transition temperature (T_{T3}) and the second phase transition temperature (T_{T2}) is at least 50° C.

Clause 38. A multi-member assembly (200) comprising: a first structural member (202); a second structural member (204) opposed from the first structural member (202); and a fire seal (100) positioned between the first structural member (202) and the second structural member (204), the fire seal (100) comprising: a bulk material (110); and a phase-changing material (120) supported by the bulk material (110), wherein the bulk material (110) is fire resistant.

Clause 39. The multi-member assembly (200) of Clause 38, wherein the first structural member (202) is an engine and wherein the second structural member (204) is a pylon.

Clause 40. A fire-sealing method comprising: positioning a fire seal (100) between a first structural member (202) and a second structural member (204), the fire seal (100) comprising: a bulk material (110); and a phase-changing material (120) supported by the bulk material (110), wherein the bulk material (110) is fire resistant.

Clause 41. The method of Clause 40, wherein the first structural member (202) is an engine and wherein the second structural member (204) is a pylon.

Although various examples of the disclosed fire seals and fire-sealing methods have been shown and described, modifications may occur to those skilled in the art upon reading the specification. The present application includes such modifications and is limited only by the scope of the claims.

What is claimed is:

1. A fire seal comprising:
a bulk material; and
a phase-changing material supported by the bulk material,
wherein the bulk material is fire resistant.

2. The fire seal of claim 1, wherein the bulk material decomposes at a decomposition temperature, and wherein the decomposition temperature is at least 400° C.

3. The fire seal of claim 1, wherein the bulk material decomposes at a decomposition temperature, and wherein the decomposition temperature is at least 500° C.

4. The fire seal of claim 1, wherein the bulk material decomposes at a decomposition temperature, and wherein the decomposition temperature is at least 600° C.

5. The fire seal of claim 1, wherein the phase-changing material has a phase transition temperature, and wherein the phase transition temperature is between approximately 50° C. and approximately 1000° C.

6. The fire seal of claim 1, wherein the phase-changing material has a phase transition temperature, and wherein the phase transition temperature is between approximately 100° C. and approximately 900° C.

7. The fire seal of claim 1, wherein the phase-changing material has a phase transition temperature, and wherein the phase transition temperature is between approximately 250° C. and approximately 800° C.

8. The fire seal of claim 1, wherein the phase-changing material has a phase transition temperature and the bulk material has a decomposition temperature, and wherein a difference between the phase transition temperature and the decomposition temperature is at least 10° C.

9. The fire seal of claim 8, wherein a difference between the phase transition temperature and the decomposition temperature is at least 20° C.

10. The fire seal of claim 8, wherein a difference between the phase transition temperature and the decomposition temperature is at least 30° C.

11. The fire seal of claim 1, wherein the phase-changing material has a phase transition temperature, and wherein the phase-changing material transitions from a solid to a liquid upon reaching the phase transition temperature.

12. The fire seal of claim 1, wherein the phase-changing material comprises particles having an average particle size of less than 1 μm.

13. The fire seal of claim 1, wherein the phase-changing material comprises a metallic material.

14. The fire seal of claim 1, further comprising a second phase-changing material supported by the bulk material.

15. The fire seal of claim 14, wherein:
the second phase-changing material has a second phase transition temperature,
the bulk material has a decomposition temperature, and
a difference between the second phase transition temperature and the decomposition temperature is at least 10° C.

16. The fire seal of claim 14, wherein the second phase-changing material has a second phase transition temperature and wherein a difference between a phase transition temperature of the phase-changing material the second phase transition temperature is at least 50° C.

17. The fire seal of claim 14, further comprising a third phase-changing material supported by the bulk material.

18. The fire seal of claim 1, further comprising an infrared-reflective coating on an outside surface of the fire seal.

19. A multi-member assembly comprising:
a first structural member;
a second structural member opposed from the first structural member; and
a fire seal positioned between the first structural member and the second structural member, the fire seal comprising:
a bulk material; and
a phase-changing material supported by the bulk material,
wherein the bulk material is fire resistant.

20. A fire-sealing method comprising:
positioning a fire seal between a first structural member and a second structural member, the fire seal comprising:
a bulk material; and
a phase-changing material supported by the bulk material,
wherein the bulk material is fire resistant.
